(19) United States
(12) Patent Application Publication
(10) Pub. No.: US 2025/0315902 A1
(43) Pub. Date: Oct. 9, 2025

(54) ELECTRIC VEHICLE (EV) CHARGING COUPLER HOLSTERED DETECTION SYSTEM (CHDS)

(71) Applicant: BarrellCharge Solutions, Inc., Austin, TX (US)

(72) Inventors: Steve A. Tarnowsky, West Bloomfield, MI (US); William D. Marsh, Austin, TX (US)

(21) Appl. No.: 19/169,070

(22) Filed: Apr. 3, 2025

Related U.S. Application Data
(60) Provisional application No. 63/573,807, filed on Apr. 3, 2024.

(51) Int. Cl. G06Q 50/06; B60L 53/16; B60L 53/18; B60L 53/66; B60L 53/68; G06Q 30/0283

(52) U.S. Cl. CPC G06Q 50/06; B60L 53/16; B60L 53/18; B60L 53/665; B60L 53/68; G06Q 30/0283

(57) ABSTRACT

Disclosed is electric vehicle supply equipment (EVSE) with a coupler holstered detection system (CHDS). The EVSE includes an electric cable extending from the EVSE with a coupler for supplying electrical current. The coupler is connectable to and dis-connectable from a charging port of an electric vehicle (EV). A holster holds the coupler when the coupler is not charging the EV and releases the coupler to enable connection to a charging port. A sensor detects when the holster is in a first state when the coupler is held by the holster and/or in close proximity of the holster and in a second state when the coupler has been released by the holster and/or not within close proximity of the holster. A manager is configured to detect when the sensor is in the first and second states and can communicate the states to appropriate ore user communications devices.

### CLAIM OF PRIORITY

This application claims priority to and the benefit of U.S. Patent Application entitled “Electric Vehicle (EV) Charging Coupler Holstered Detection System (CHDS),” filed on Apr. 3, 2024, under application no. 63/573,807, which is incorporated herein by reference in its entirety.

### FIELD OF THE INVENTION

The embodiments of the present disclosure generally relate to electric vehicle charging stations and equipment for charging electric vehicles (EVs).

### BACKGROUND OF THE INVENTION

Electric vehicle supply equipment (EVSE) supplies electricity to an electric vehicle (EV). Commonly called “charging stations” or “charging docks,” they provide electric power to the EV and use that to recharge the EV's batteries. EVSE systems include the electrical conductors, related equipment, software, and communications protocols that deliver energy efficiently and safely to the vehicle.

In general, EVSE equipment is classified as Level 1 (120 volts AC), Level 2 (240 volts, AC), and DC Fast Charger (480 volts DC and higher).

As battery EV market penetration increases, there will be growing demand for public charging. While most EV charging customers return the vehicle charging coupler to a holster associated with the EVSE, after completing a charge event, a coupler could inadvertently or purposefully be improperly holstered, leading to subsequent damage. A damaged coupler or connecting EVSE cable can cause that particular EVSE to fault and not be available for charging EVs. Damaged coupler/cable assemblies are one of the leading causes of unavailable public EVSE.

### SUMMARY OF THE INVENTION

Embodiments of an electric vehicle supply equipment (EVSE) with a charging coupler holstered detection system (CHDS) are disclosed.

One embodiment, among others, is electric vehicle supply equipment (EVSE). The EVSE includes a flexible electric cable connected to the EVSE for supplying electricity. An electrical coupler is connected to the cable. The coupler is designed to be connectable to and dis-connectable (mechanically and electrically) from a charging port associated with an electric vehicle (EV). A holster holds the coupler when the coupler is not in use charging the electric vehicle and releases the coupler, when a charging event is to occur in order to enable connection to the charging port. A sensor detects when the holster is in a first state and in a second state. The first state is when the coupler is held by the holster and/or is in close proximity of the holster (e.g., when the coupler is within a predetermined, or predefined, distance from the holster, etc.). The second state is when the coupler has been released by the holster and/or is not in close proximity of the holster. A manager in electrical communication with the sensor is configured to detect when the sensor is in the first and second states and can communicate the states to one or more remote user communications devices associated with users.

Another embodiment, among others, is a method for monitoring status of coupler holstering at electric vehicle supply equipment (EVSE). The method can be broadly summarized as follows: providing EVSE for charging EVs at a plurality of locations; at each EVSE, sensing when a coupler is within a predetermined proximity of a holster associated with the EVSE and generating a state signal indicative thereof; and monitoring the state signals in order to determine whether or not assistance is needed at one or more of the EVSE.

Other embodiments, systems, apparatus, methods, features, and advantages of the present invention will be apparent to one with skill in the art upon examination of the following drawings and detailed description. It is intended that all such additional embodiments, systems, apparatus, methods, features, and advantages be included within this disclosure, be within the scope of the present invention, and be protected by the accompanying claims.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure.

FIG. 1 is a diagram of the preferred embodiment of the EV charging coupler holstered detection system (CHDS) in accordance with the present disclosure.

FIG. 2 a functional block diagram of the CHDS of FIG. 1.

FIG. 3 is a diagram of the dispenser with (a) holster assembly having integrated proximity sensor and (b) a vehicle coupler that is holstered in the holster assembly when not in use charging an EV.

FIG. 4 is a flow chart showing the logic and process implemented by the manager associated with the CHDS of FIG. 1.

### DETAILED DESCRIPTION OF PREFERRED EMBODIMENT(S)

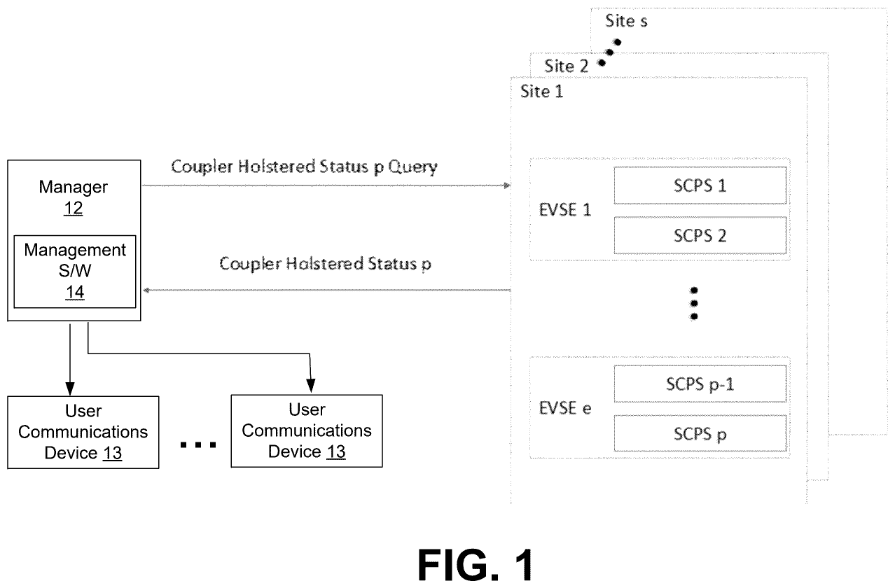

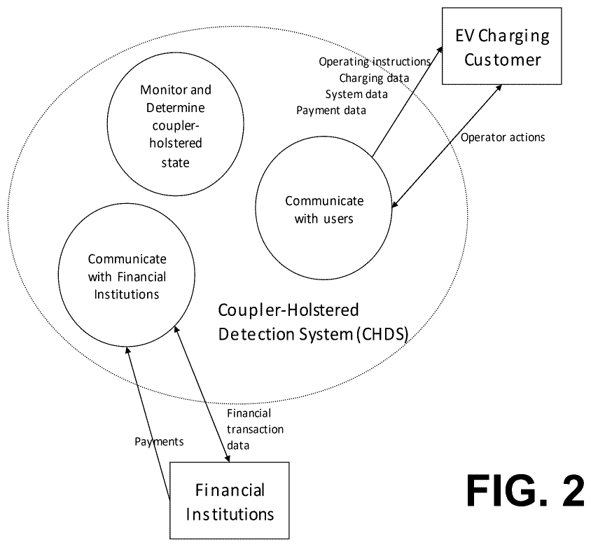

As shown in FIGS. 1 and 2, the EV charging coupler holstered detection system (CHDS) 10 provides a method of proximity detection and state communication embedded into the EVSE such that a mis-holstered coupler can be remedied before it is subsequently damaged. As a nonlimiting example, in the preferred embodiment, the coupler is designed in compliance with the North American Charging Standard” (NACS). The coupler is designed to charge with both AC and DC ports at a maximum output current of 48 amps (AC) and 400 amps (DC) and with a maximum power of 250 kW.

The manager 12, or controller, of the CHDS determines a given site's EVSE charging coupler holstered state, continues to monitor that state, communicates with the EV charging customer via a user communication device 13 regarding the detected state, and communicates with any third-party financial institutions should a discount or penalty be applied to any particular charging event. In the preferred embodiment, the manager 12 is a computer having suitable management software 14 that manages the CHDS 10.

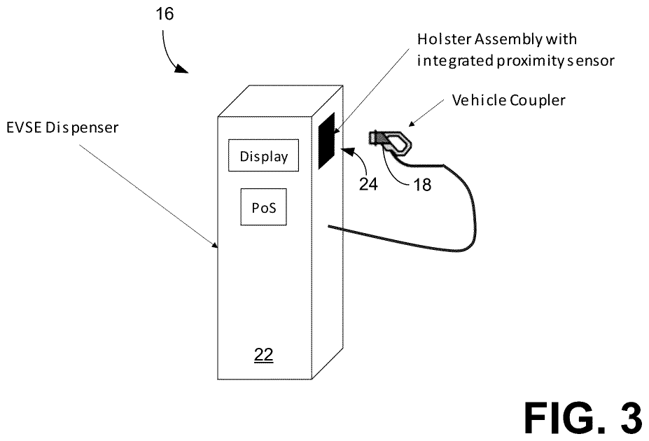

FIG. 3 shows a typical EVSE charging dispenser 16 where the vehicle coupler 18 can be holstered into the dispenser assembly 22 when not in-use to minimize the risk of accidental damage from being run over by a vehicle. A proximity sensor 24 is integrated into the holster assembly 22 to detect whether the vehicle coupler 18 is properly holstered when not in use. Proximity detection may be accomplished by any of a number of well-known methods including physical switches or non-physical methods that use ultrasonic or electromagnetic means. Each EVSE at a given site has a holster assembly 24 with an integrated proximity sensor for each of its vehicle couplers 18 labeled as site coupler proximity sensor (SCPS) p. Each sensor is assigned a unique identity across all of the EVSE and sites being managed by the CHDS 10.

As specific nonlimiting examples, the following sensors can be used: a capacitive, inductive, magnetic, optical, or ultrasonic proximity sensor, or a combination thereof. A good description of the foregoing sensors and their respective tradeoffs is set forth at https://robocraze.com/blogs/post/proximity-sensor-types, which is incorporated herein by reference in its entirely.

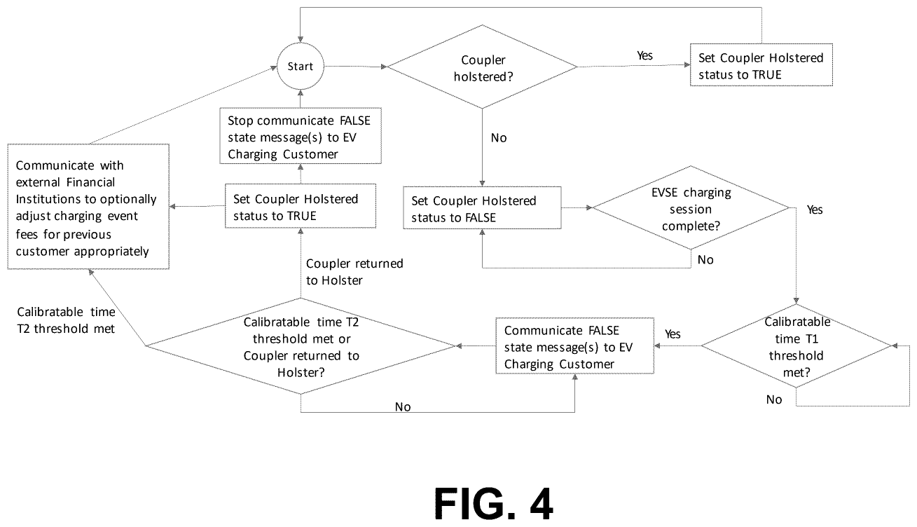

As shown in FIG. 4, each EVSE at a given site has an integrated proximity sensor 24 for each of its vehicle couplers 18 labeled as site coupler proximity sensor (SCPS) p. Each sensor is assigned a unique identity across all of the EVSE and sites being managed by CHDS. For each SCPS, the CHDS assigns a coupler holstered status of TRUE or FALSE. When the manager of the CHDS detects a coupler-holstered state of FALSE for any of the couplers across the managed EVSE sites, a coupler-holstered status message is sent via the internet and/or sms text messaging to the manager of the EVSE equipment at a given instance of CHDS installation. The coupler-holstered status also includes the unique identifier SCPS p. Coupler holstered status could also be queried by the user via the internet.

With further reference to FIG. 4, if a specific SCPS is set to FALSE within a calibratable time period following the termination of an EV charging event, the CHDS would assign the unholstered coupler event to the user of the EVSE, communicate associated message(s) to that user after calibratable time T1 and if not remedied within a calibratable amount of time T2, could subsequently charge an additional fee against that user's account for failing to return the coupler to its holster following the charge event. The message(s) can be communicated to the user via any suitable output device, for example but not limited to, a display. As an alternative to the additional fee approach, the CHDS could incentivize the EV charge user via display messaging (or alternative method), essentially reminding the user to return the coupler to the holster and offer discounted charging rates (or alternative incentives) to encourage proper holstering of the vehicle coupler before leaving the charging site.

While detecting the presence of a nearby device and corresponding notification is not by itself novel, the vast majority of EV charging is not monitored in real-time by anyone other than the EV charging customer. Should a coupler 18 not be returned to the EVSE holster assembly 24 (either properly or at all), there is typically nobody to remedy the situation prior to the next EV charging customer. The value and novelty of this invention becomes evident in a broader application of managed and monitored EVSE where subsequent action and remedy can be taken, thus precluding potential subsequent damage.

Finally, it should be emphasized that the above-described embodiment(s) of the present invention is merely a possible nonlimiting example of an implementation, merely set forth for a clear understanding of the principles of the invention. Many variations and modifications may be made to the above-described embodiment(s) of the invention without departing substantially from the spirit and principles of the invention. All such modifications and variations are intended to be included herein within the scope of this disclosure and the present invention.

At least the following is claimed:

1. Electric vehicle supply equipment (EVSE), comprising:
a flexible electric cable connected to the EVSE for supplying electricity;
an electrical coupler connected to the cable, the coupler designed to be connectable to and dis-connectable from a charging port associated with an electric vehicle (EV); and
a holster designed to hold the coupler when the coupler is not in use charging the EV and to release the coupler to enable connection to the charging port; and
a sensor designed to detect when the holster is in a first state and in a second state, the first state being when the coupler is held by the holster, the second state being when the coupler has been released by the holster.

2. The equipment of claim 1, further comprising a manager in electrical communication with the sensor and configured to detect when the sensor is in the first and second states.

3. The equipment of claim 2, further comprising a user communications device in electrical communication with the manager via the internet, in whole or in part.

4. The equipment of claim 2, further comprising a user communications device in electrical communication with the manager via a short message service (SMS) text message.

5. The equipment of claim 1, wherein the manager is configured to provide an output to a user that is indicative of whether or not the coupler is within a predetermined proximity of the holster.

6. The equipment of claim 1, wherein the manager is configured to provide an output to a user that indicates that a discount will be applied to an electricity purchase if the coupler is re-holstered after charging the EV.

7. The equipment of claim 1, wherein the manager is configured to provide an output to a user that indicates that a monetary amount will be added to an electricity purchase if the coupler is not re-holstered after charging an electric vehicle.

8. The equipment of claim 1, wherein the sensor is designed to determine whether or not the coupler is within a predetermined proximity of the holster.

9. A system, comprising:
(a) a plurality of electric vehicle supply equipment (EVSE), each having:
(1) a flexible electric cable connected to the EVSE for supplying electrical current;
(2) an electrical coupler connected to the cable, the coupler designed to be connectable to and dis-connectable from a charging port associated with an electric vehicle; and
(3) a holster designed to hold the coupler when the coupler is not in use charging the electric vehicle and to release the coupler to enable connection to the charging port; and
(4) a sensor designed to detect when the holster is in a first state and in a second state, the first state being when the coupler is in close proximity of the holster, the second state being when the coupler is not in close proximity of the holster; and
(b) a manager in electrical communication with the sensors and configured to detect when the sensors are each in the first and second states.

10. The system of claim 9, further comprising a user communications device in electrical communication with the manager via the internet, in whole or in part.

11. The system of claim 9, further comprising a user communications device in electrical communication with the manager via a short message service (SMS) text message.

12. The system of claim 9, wherein the sensor is designed to determine whether or not the coupler is within a predetermined proximity of the holster.

13. The equipment of claim 9, wherein the manager is configured to provide an output to a user that is indicative of whether or not the coupler is within a predetermined proximity of the holster.

14. The equipment of claim 9, wherein the manager is configured to provide an output to a user that indicates that a discount will be applied to an electricity purchase if the coupler is re-holstered after charging the EV.

15. The equipment of claim 9, wherein the manager is configured to provide an output to a user that indicates that a monetary amount will be added to an electricity purchase if the coupler is not re-holstered after charging an electric vehicle.

16. A method for monitoring status of coupler holstering at electric vehicle supply equipment (EVSE), the method comprising the steps of:
providing a plurality of EVSE for charging electric vehicles respectively at a plurality of locations;
at each EVSE, sensing when a coupler is within a predetermined proximity of a holster associated with the EVSE and generating a state signal indicative thereof; and
monitoring the state signals in order to determine whether or not assistance is needed at one or more of the plurality of EVSE.

17. The method of claim 16, further comprising the steps of:
receiving an identifier that uniquely identifies a particular EVSE along with a corresponding state signal;
selecting a particular communications device based upon the identifier; and
communicating a message to the particular communications device that indicates a state of the particular EVSE.

18. The method of claim 16, further comprising the step of providing an output to a user that is indicative of whether or not the coupler is within the predetermined proximity.

19. The method of claim 16, further comprising the step of providing an output to a user that indicates that a discount will be applied to an electricity purchase if the coupler is re-holstered after charging an electric vehicle.

20. The method of claim 16, further comprising the step of providing an output to a user that indicates that a monetary amount will be added to an electricity purchase if the coupler is not re-holstered after charging an electric vehicle.
